(19) United States
(12) Patent Application Publication
(10) Pub. No.: US 2007/0297165 A1
(43) Pub. Date: Dec. 27, 2007

(54) LIGHT FOR A BASKETBALL SYSTEM

(76) Inventors: Neil Watson, Layton, UT (US); Gary Phillips, Clearfield, UT (US); S. Curtis Nye, Clinton, UT (US); Sharon Jones, Clearfield, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/769,606

(22) Filed: Jun. 27, 2007

Related U.S. Application Data
(63) Continuation-in-part of application No. 11/625,664, filed on Jan. 22, 2007.
(60) Provisional application No. 60/818,150, filed on Jun. 29, 2006.
(60) Provisional application No. 60/760,720, filed on Jan. 20, 2006.

(51) Int. Cl. F21S 8/00

(52) U.S. Cl. 362/145

(57) ABSTRACT

A lighting system for a basketball system may be movable between a first position in which the lighting system is disposed behind the backboard and a second position in which the lighting system is disposed in front of the backboard to allow maintenance to be performed on the lighting system. When the lighting system is in the second position, the lights are preferably disposed at least proximate the rim. Advantageously, the lighting system may be pivotally connected to the support pole of the basketball system by at least some of the same structure that connects the basketball goal to the support pole. In addition, if the height of the basketball goal is adjustable, that may allow the height of the lights to be adjusted when the lighting system is in the second position.

### CROSS-REFERENCE TO RELATED APPLICATIONS

This application claims priority to and the benefit of U.S. provisional patent application Ser. No. 60/818,150, which was filed on Jun. 29, 2006 and entitled LIGHT FOR A BASKETBALL SYSTEM.

This application is a continuation-in-part of U.S. patent application Ser. No. 11/625,664, which was filed on Jan. 22, 2007 and entitled LIGHT FOR A BASKETBALL SYSTEM; which claims priority to and the benefit of U.S. provisional patent application Ser. No. 60/760,720, which was filed on Jan. 20, 2006 and entitled LIGHT FOR A BASKETBALL SYSTEM.

These applications are incorporated by reference in their entireties.

### BACKGROUND OF THE INVENTION

1. Field of the Invention

The present invention generally relates to basketball systems and, in particular, to lights for a basketball system.

2. Description of Related Art

Basketball is a very popular sport and it is frequently played indoors and outdoors. Indoor basketball courts, however, are often relatively expensive to construct and may not be readily available. Accordingly, basketball is often played outdoors. Unfortunately, many people have jobs, school, family and/or other commitments during the day that prevents them from playing basketball during the day. Thus, basketball is often played outdoors in the evening or at night. Disadvantageously, it is often difficult to play basketball in the evening because there is not sufficient light.

It is known to use a lighting system to allow basketball to be played at night. Many conventional outdoor lighting systems, however, do not provide sufficient light for playing basketball. For example, some conventional lighting systems may fail to adequately illuminate the playing surface, the basketball backboard or the basketball rim. In addition, many conventional lighting systems can be expensive to purchase and time consuming to install. Further, many such lighting systems require large and complex support structures. These known lighting systems may also be difficult to repair and maintain. For example, many conventional lighting systems require a very tall ladder, such as twelve to fifteen feet in height, to replace the light bulbs.

Some conventional outdoor lighting systems may include lights that are positioned four to five feet above and four to five feet in front of the basketball backboard. This is an area, however, where players often look while playing basketball. For example, many players attempting to rebound a basketball will look directly into the lights, which can substantially impair their vision and may be distracting. In addition, while players are attempting to shoot the basketball, they may look directly into the lights, especially if they are attempting a shot close to the basket.

These known lighting systems with lights four to five feet above and four to five feet in front of the basketball backboard may also interfere with playing or practicing basketball because the basketball may strike the lights while the ball is in play. For example, the ball may strike the lights or the support structure for the lights while shooting a high arcing shot, when attempting a shot from the sides of the court or when trying a desperation shot. When the lights are struck by the basketball, they can be broken or damaged. In addition, because these known lighting systems may intrude into the court or area of play, this may disrupt or stop the game. If play is stopped or disrupted, the game or practice may have to be reset or restarted, which may have a negative impact on the game or practice.

### BRIEF SUMMARY OF EMBODIMENTS OF THE INVENTION

A need therefore exists for a basketball system that reduces or eliminates the above-described disadvantages and problems.

One aspect is a basketball system that may include a basketball goal, which may include a backboard, a rim and a net. The basketball system may also include a support structure that is sized and configured to support the basketball goal at a desired height above a playing surface. The support structure, for example, may include a support pole and the support pole may consist of a single segment or it may consist of multiple segments that are interconnected.

Another aspect is a basketball system that may include a basketball goal that is adjustable in height. For example, the basketball goal may be disposed so that the rim is located ten feet above the playing surface, which is the conventional height for a basketball goal. The basketball goal may also be disposed in other positions so that the rim is located at other heights. In particular, the rim may be located at lower heights, such as nine feet, eight feet, seven feet, six feet or other desired heights. The rim may also be located at a greater height, if desired. Advantageously, this may allow a wide range of people with different abilities and skills to use the basketball system.

Yet another aspect is a basketball system that may be capable of being disposed in a fixed or permanent location. For example, the basketball system may be an in-ground basketball system that is disposed in fixed position. The basketball system may also be a portable basketball system that is sized and configured to be moved from one location to another location. For instance, the basketball system may be connected to a base that is sized and configured to be filled with ballast such as water or sand. The portable basketball system may include wheels to facilitate movement of the basketball system. The portable basketball system may also include a handle that may be used to help move the basketball system from one location to another location.

Still another aspect is a basketball system that may include a rim that can be moved or pivoted. For example, the rim may be a break-away type rim in which the rim may move or pivot downwardly when a large force or impact is applied to the rim, such as when a player dunks a basketball or grabs the rim.

A further aspect is a basketball system that may include a lighting system. The lighting system may include one or more lights and the lighting system may facilitate playing basketball in various lighting conditions. Preferably, the lighting system amply illuminates at least a portion of the playing surface, backboard, rim and net to allow playing basketball at night or in low lighting conditions.

A still further aspect is a basketball system that may include a lighting system which does not interfere with playing basketball. For example, the lighting system may include lights that are positioned behind the basketball goal. In particular, the lights may be positioned behind the basketball backboard. With the lights positioned behind the basketball backboard, players are not likely to hit the lights while shooting and the ball is unlikely to hit the lights when bouncing off the rim or backboard. Thus, the lighting system is unlikely to interfere with playing or practicing basketball. Also, positioning the lights behind the a basketball backboard may significantly decrease the chances that the lights will be struck by a basketball, which may decrease the risk that the lights could damaged or broken. Furthermore, with the lights positioned behind the basketball backboard, players are less likely to look directly into the lights when shooting or rebounding, which may help players from being temporarily distracted or blinded.

Yet another further aspect is a basketball system that may include a lighting system with one or more lights that may face in one or more desired directions. For example, the lights may face downwardly, sideways, upwardly or at various angles. Preferably, the lights are movable or adjustable so that the lights can be positioned in any desired direction or location. The lights are preferably independently adjustable, which may facilitate use of the lighting system.

Another aspect is a basketball system that may include a lighting system and a basketball backboard constructed from a material through which at least some light may be transmitted. If the lights are positioned behind the backboard, then the light may pass through the backboard to illuminate, for example, the rim and net. Advantageously, this may create a lighting system with fewer shadows and improved visibility.

Still another aspect is a basketball system that may include a lighting system with a support structure that is sized and configured to support the lights. The lighting support structure is preferably sized and configured to hold the lights in a generally fixed position behind the basketball goal. For example, the lighting support structure may have a generally T-shaped configuration with a first light attached to one end of an elongated support member and a second light attached to the other end of the support member. The lights are preferably spaced apart to help provide a wider breadth of illumination. The lighting system is preferably constructed of metal tubing, such as one inch by three inch rectangular tubing or two inch by three inch rectangular tubing. Of course, the lighting system may be constructed from other suitable materials and may have other appropriate shapes, sizes, configurations and arrangements depending, for example, upon the intended use of the lighting system or basketball system.

Yet another aspect is a basketball system that may include a lighting system that may move between a first position in which the lights are positioned for use and a second position in which the lights are positioned for maintenance. For example, in the first position, the lights may be positioned behind the basketball goal and the basketball backboard, which may allow the basketball system to be used for playing or practicing. In the second position, the lights may be positioned for maintenance, such as changing the light bulbs.

Still yet another aspect is a basketball system that may include a lighting system which may be secured in different positions. For example, the lighting system may include an elongated support member that is pivotally connected to the support structure of the basketball system, such as a support pole. In particular, the elongated support member of the lighting system may include a first end, a second end and an intermediate portion that is pivotally connected to a top portion of the support pole. When the lighting support structure is in a first position, the first end of the elongated support member may be connected to the support pole by a fastener, such as a bolt, bracket, clip, strap and the like. To move the lighting support structure from the first position to a second position, the first end of the elongated support member may be disconnected from the support pole.

A further aspect is a basketball system that may include a lighting system with a biasing member that is sized and configured to bias the lighting system into a desired position. The biasing member could also be sized and configured to facilitate moving the lighting system between the positions. The biasing member may be a dampener, spring, shock, elastic member and the like. The lighting system, however, does not require a biasing member.

A still further aspect is a basketball system that may include a lighting system which is movable between different positions and a retaining member that is sized and configured to limit the movement of the lighting system. The retaining member, which could be a line, tether, chain, rope, cable, cord or the like, may restrict the movement of the lighting system. The retaining member may be sized and configured to limit the rotational movement of the lighting system and/or the retaining member may be sized and configured to at least help prevent the lighting support structure from pivoting or moving past a desired position. Thus, the retaining ember may be used to prevent the lighting system from inadvertently hitting other objects such as the basketball goal, the ground and the like.

Yet another further aspect is a basketball system that may include a height adjustable basketball goal and a lighting system. Advantageously, the lighting system may be sized and configured so that it does not hinder or interfere with adjusting the height of the basketball goal. In addition, the height adjustable basketball goal may be used to position the lighting system at a desired height. For example, the lighting system may be positioned so that it contacts an upper portion of the basketball goal. Because the height of the basketball goal may be adjusted, the height of the lighting system may also be adjusted. This may allow, for example, the lights to be more easily changed because the height of the lights may be adjusted. Accordingly, a tall ladder may not be required to change the lights of the lighting system.

Another aspect is a basketball system that may include a lighting system which can be quickly and easily connected to a basketball system. For example, the basketball system may include a basketball goal, a support structure and a connecting structure that connects the basketball goal to the support structure. The connecting structure may include a first pair of arms connected to the support structure and the basketball goal, and a second pair of arms connected to the support pole and the basketball goal. The first pair of arms may be connected to the support structure by a fastener, such as a bolt, and the lighting system may be connected to the support structure by the same bolt.

Still another aspect is a lighting system for a basketball system that may include a basketball goal, a support structure that is sized and configured to support the basketball goal above a playing surface, and a connecting structure that connects the basketball goal and the support structure. The lighting system may be movable between a first position and a second position relative to the support structure of the basketball system. For example, in the first position, the lighting system may be disposed behind the basketball goal and the basketball system may be capable of being used. In the second position, the lighting system may be at least partially disposed in front of the basketball goal to allow maintenance to be performed on the lighting system. The lighting system may include a lighting support structure with a first end, a second end and a connecting portion disposed between the first end and the second end. The connecting portion is preferably pivotally connected to the support structure of the basketball system to facilitate movement of the lighting system between the first and second positions. The lighting system may also include one or more lights attached to the first end of the lighting support structure. In addition, the lighting system may include an attachment mechanism that selectively connects the second end of the lighting support structure to the support structure of the basketball system to secure the lighting system in the first position. Advantageously, the connecting structure of the basketball system may be pivotally connected to the support structure of the basketball system by a connecting member or bracket and the connecting portion of the lighting system is pivotally connected to the same connecting member or bracket.

Yet another aspect is a lighting system for a basketball system that may include a support structure that is pivotally connected to a support structure of the basketball system. The support structure for the lighting system may be movable between a first position in which the lights are disposed behind the backboard and the basketball system capable of being used, and a second position in which the lights are at least partially disposed in front of the backboard and to allow maintenance to be performed on the lighting system. The lighting system may further include an attachment mechanism that selectively connects at least a portion of the lighting support structure to the support structure of the basketball system.

Advantageously, the basketball goal and the lighting system may be pivotally connected to the support structure of the basketball system by the same structure. In addition, the basketball system may include a height adjustment mechanism that allows the height of the basketball goal to be adjusted relative to the playing surface. The height adjustment mechanism of the basketball system may also be used to adjust the height of the lighting system. Because the lights of the lighting system are preferably disposed at least proximate the rim when the lighting system is in contact with the basketball goal, that may allow maintenance to be more easily performed on the lighting system.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a front perspective view of an exemplary basketball system and an exemplary lighting system, illustrating the lighting system in a use position;

FIG. 2 is an enlarged, rear perspective view of a portion of the basketball system and lighting system shown in FIG. 1;

FIG. 3 is an enlarged, front perspective view of the basketball system and lighting system shown in FIG. 1, illustrating the lighting system in a maintenance position;

FIG. 4 is an enlarged perspective view of a portion of the basketball system shown in FIG. 3, illustrating the attachment of the lighting system to the basketball system;

FIG. 5 is a perspective view of another exemplary lighting system that may be used in connection with a basketball system;

FIG. 6 is a perspective view of still another exemplary lighting system that may be sued in connection with a basketball system;

FIG. 7 is an enlarged view of a portion of the lighting system shown in FIG. 6;

FIG. 8 is a perspective view of an exemplary basketball system with a height adjustment mechanism that may be used in connection with the basketball system and/or lighting system; and

FIG. 9 is an enlarged view of a portion of the basketball system shown in FIG. 8 with an exemplary lighting system connected to the basketball system.

### DETAILED DESCRIPTION OF PREFERRED EMBODIMENTS

The present invention is generally directed towards lights for a basketball system. The principles of the present invention, however, are not limited to lights for basketball systems. It will be understood that, in light of the present disclosure, the lights and lighting system disclosed herein can be successfully used in connection with other types of support structures, sporting equipment and the like.

Additionally, to assist in the description of the lights for a basketball system, words such as top, bottom, front, rear, right and left are used to describe the accompanying figures, which are not necessarily drawn to scale. It will be appreciated that the lights and the basketball system can also be located in a variety of other desired positions and locations.

Further, the lights and lighting system are described below in connection with an exemplary basketball system. It will be understood that the basketball system could have other suitable aspects, features, components, shapes, sizes, configurations and arrangements depending, for example, upon the intended use of the lighting system and/or basketball system. A detailed description of the lights for a basketball system now follows.

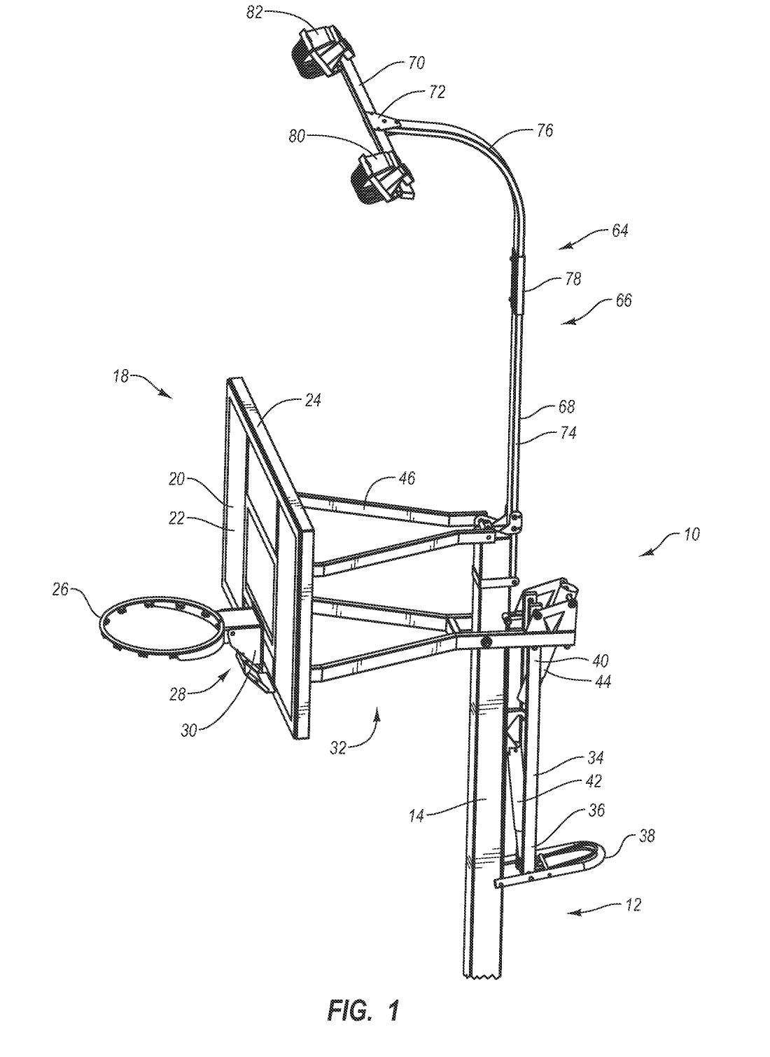

As seen in FIG. 1, the basketball system 10 may include a support structure 12 that is sized and configured to support the basketball system relative to a playing surface. The support structure 12 may consist of an elongated support member, such as a pole 14. The pole 14 may include one or more segments that are interconnected, which may facilitate shipping and transportation of the basketball system 10, or the pole may consist of a single elongated structure. The pole 14 preferably has a hollow interior to decrease the weight of the support structure 12 and the pole may have a generally square cross-sectional configuration. The pole 14 is also preferably constructed from relatively strong and durable materials, such as steel, but it may also be constructed from other materials with suitable properties and characteristics. It will be appreciated that the pole 14 and/or the support structure 12 may have other suitable shapes, sizes, configurations and arrangements depending, for example, upon the intended use of the basketball system 10. For example, the support structure 12 could include multiple components and/or segments, the pole could be disposed at various angles, and the like.

The basketball system 10 may be part of a portable basketball system that is capable of being moved or a permanent system that is intended to remain in a fixed location. For example, the support structure 12 may be connected to a base to form part of a portable basketball system. The support structure 12 may also be connected to the ground to form an in-ground or permanent basketball system 10. Advantageously, the basketball system 10 may be used in connection with either a portable or permanent basketball system.

The basketball system 10 may include a basketball goal 18, which may include a basketball backboard 20. The backboard 20 may consist of a single structure or it may include multiple components that are interconnected. For example, as shown in FIG. 1, the backboard 20 may include a rebound member 22 and a frame 24. The rebound member 22 may consist of a sheet of acrylic material with a generally planar front surface and the rebound member may be generally transparent or translucent to allow light to pass through the backboard 20.

In particular, the rebound member 22 is preferably constructed from a relatively clear, transparent and/or translucent material, which may allow light from a lighting system to pass though the rebound member. In addition, all or a portion of the rebound member 22 may be tinted, colored, painted, silk-screened and like. The rebound member 22 may also include a coating, finish, layer, film or the like. If desired, the rebound member 22 may include graphics, designs and the like depending, for example, upon the intended aesthetics and/or use of the backboard 20. It will be appreciated that the rebound member 22 may be constructed from other suitable materials with appropriate characteristics such as glass, plastic, polycarbonate and the like. It will also be appreciated that the rebound member 22 may be constructed from opaque materials, if desired.

The frame 24 is preferably sized and configured to support the rebound member 22. For example, the frame 24 could be disposed proximate the outer surface or perimeter of the rebound member 22. The frame 24 is preferably constructed from a relatively strong and durable material, such as steel, and the frame may be constructed from any suitable number of parts or components. If desired, the frame 24 may be sized and configured to allow as much light as possible to be transmitted through the rebound member 22. For example, the frame 24 may have a relatively small profile, be connected only to the outer portions of the rebound member and/or be constructed from transparent or translucent materials.

As shown in the accompanying figures, the backboard 20 may have a generally rectangular configuration with the rebound member 22 generally disposed within the frame 24. Preferably the front surface of the rebound member 22 is generally aligned with the front surface of the frame 24 so that the backboard has a generally planar front face, but the rebound member and frame do not have to be aligned. It will be appreciated that the backboard 20, rebound member 22 and frame 24 could have various suitable sizes, shapes, configurations and arrangements depending, for example, upon the intended use of the basketball system 10. In addition, the rebound member 22 and frame 24 could be part of a unitary structure and constructed from the same material, such as plastic, if desired.

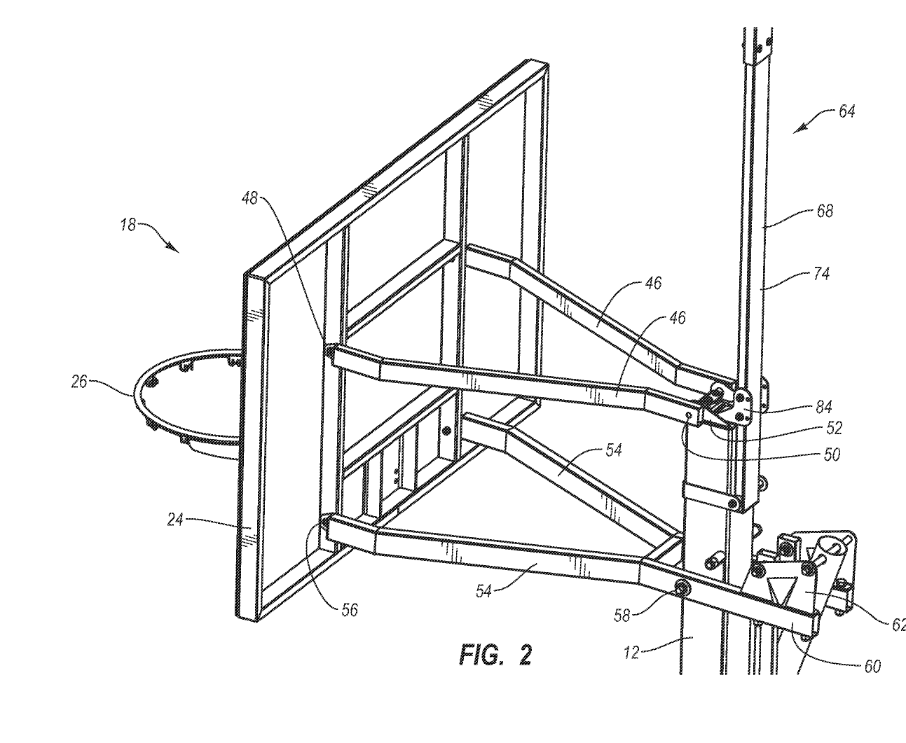

The frame 24 may also include various support members. For example, as shown in FIG. 2, the frame 24 may include various horizontal and vertical support members. The horizontal and vertical support members may be interconnected and/or connected to an outer portion of the frame 24. As discussed below, the support members may facilitate attachment of the rim to the backboard 20 and/or attachment of the backboard to the support structure 12. It will be understood that the backboard 20, rebound member 22, frame 24 and support members could have other suitable numbers, sizes, shapes, configurations and arrangements depending, for example, upon the intended use or design of the basketball system 10. It will also be appreciated that the various support members are not required.

As shown in FIG. 1, the basketball goal 18 may include a rim 26 and a net may be attached to the rim. The rim 26 may be pivotal or movable to create a break-away type rim. In particular, the rim 26 may be sized and configured to pivot or move downwardly when a force that exceeds a predetermined amount is applied to the rim. Thus, for example, if a player dunks the basketball or grasps the rim with a force that exceeds a certain amount, then the rim 26 may pivot or move downwardly. Advantageously, this may help prevent the rim 26 from being bent, deformed or otherwise damaged.

In greater detail, the rim 26 may be connected to a break-away type rim mechanism 28 that allows the rim to pivot or more downwardly when a significant force or impact is applied to the rim. The rim 26 may be securely attached to the break-away type rim mechanism 28 by welding, fasteners and the like. In addition, the rim 26 and break-away type rim mechanism 28 may be integrally formed if desired.

The break-away type rim mechanism 28 is preferably at least substantially disclosed within an enclosure 30. Advantageously, if the break-away type rim mechanism 28 is contained within the enclosure 30, then that may help protect the break-away type rim mechanism from damage. In addition, the enclosure 30 may help prevent items or objects from being caught in the break-away type rim mechanism 28. Further, the enclosure 30 may help protect the break-away type rim mechanism 28 from the elements if the basketball system 10 is used outdoors.

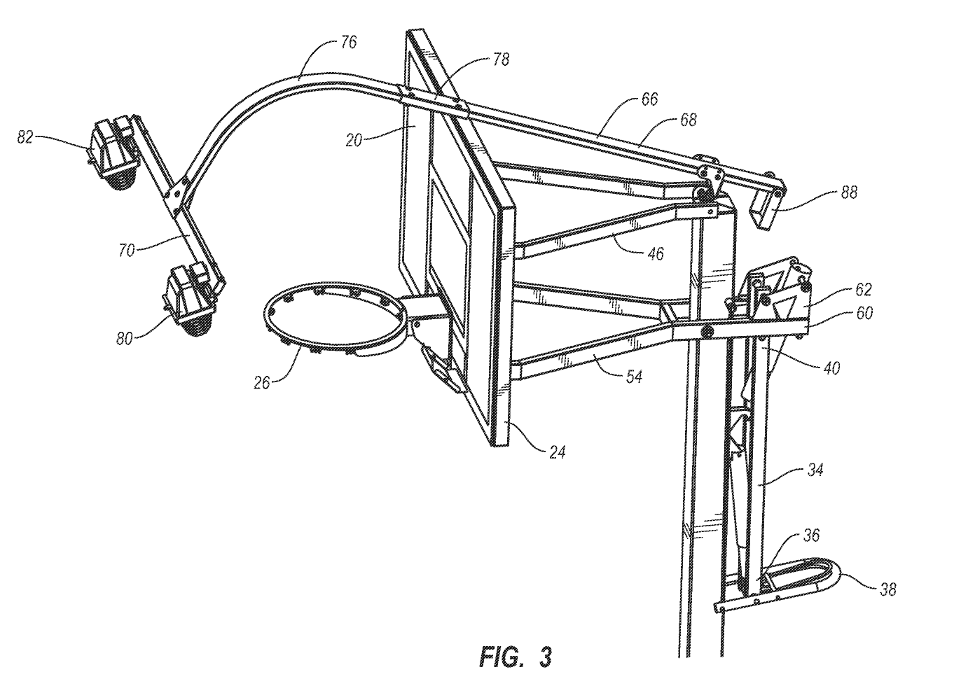

The basketball system 10 may also include a connecting structure 32 that is sized and configured to connect the basketball goal 18 to the support structure 12. The connecting structure 32 preferably allows the height of the basketball goal 18 to be adjusted. In order to facilitate adjustment of the basketball goal 18, a height adjustment mechanism 34 may be used. As best seen in FIGS. 1 and 3, the height adjustment mechanism 34 may include a first end 36 that is connected to the support structure 12 by a handle 38 and a second end 40 that is connected to a portion of the connecting structure 32. The height adjustment mechanism 34 may include one or more biasing members that are sized and configured to bias the basketball goal 18 into a desired position. In particular, the height adjustment mechanism 34 may include a first biasing member 42 and a second biasing member 44. The first biasing member 42 may include one end connected to the first end 36 and/or handle 38 of the height adjustment mechanism 34 and the other end connected to the support structure 12. The second biasing member 42 may include one end connected to the second end 40 of the height adjustment mechanism and the other end connected to the support structure. The biasing members 42, 44 may consist of springs, gas spring, shocks and the like. The biasing members 42, 44 may be sized and configured to bias the basketball goal 18 into a desired position and/or help maintain the basketball goal 18 in a desired position. It will be appreciated that the height adjustment mechanism 34 and the biasing members 42, 44 may have a variety of sizes, shapes, configurations and arrangements depending, for example, upon the intended use of the basketball system 10. It will also be appreciated that the height of the basketball goal 18 does not have to be adjustable, height adjustment mechanism 34 is not required, and one or both of the biasing members 42, 44 are not required.

As best seen in FIGS. 1-3, the connecting structure 32 preferably includes one or more support members or arms connecting the support structure 12 and the basketball goal 18. In particular, the connecting structure may include two pairs of arms that connect the support structure 12 and the basketball goal 18. The arms are preferably constructed from relatively strong and durable materials, such as steel, and the arms are preferably lightweight to help decrease the weight of the connecting structure 32. For example, the arms may be constructed from hollow steel tubes that have a generally rectangular cross-section. It will be appreciated that the arms could have other suitable sizes, shapes, configurations and arrangements depending, for example, upon the size, shape, configuration and arrangement of the support structure 12, basketball goal 18 and/or intended use of the basketball system 10. It will also be appreciated that the arms could be constructed from any suitable number of parts and components.

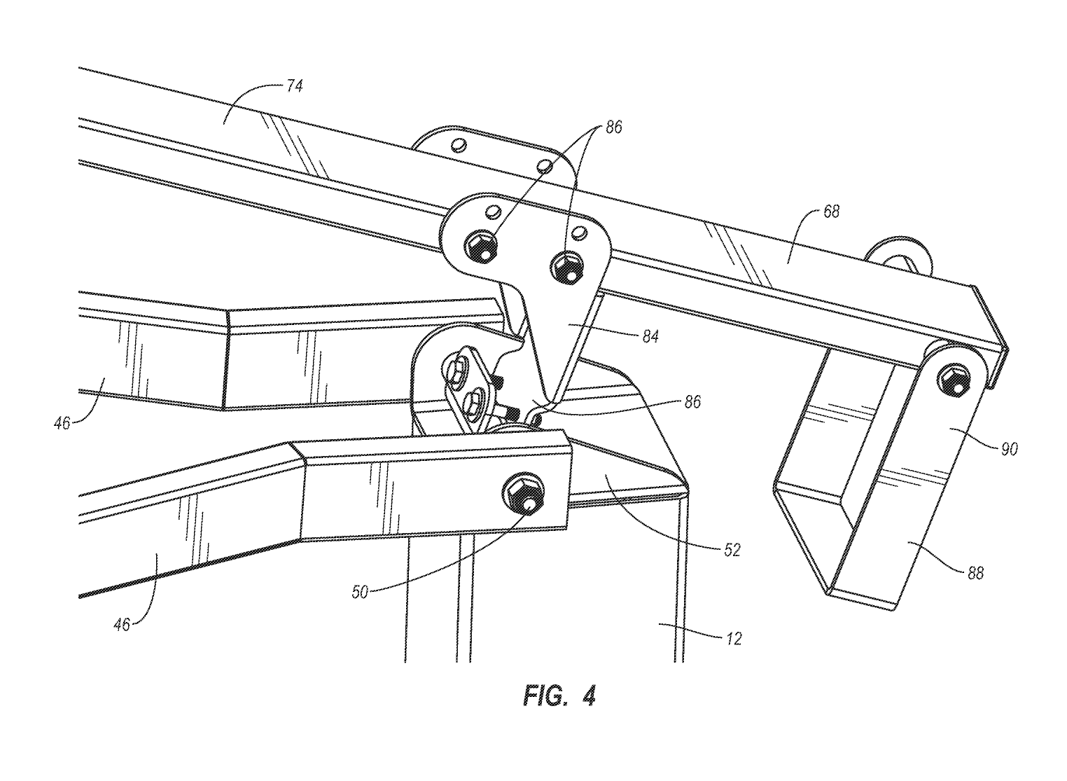

In greater detail, as best seen in FIG. 2, the connecting structure 32 may include a first pair of arms 46 connected to the support structure 12 and the basketball goal 18. One end of the first pair of arms 46 is preferably connected to the frame 24, such as the generally horizontal support members, by a fastener 48. The other end of the first pair of arms 46 is preferably connected to the support structure 12 by a fastener 50. In particular, as best seen in FIG. 4, a bracket 52 may be connected to the upper portion of the support structure 12 and the fastener 50 may connect the first pair of arms 46 to the bracket. As shown in the accompanying figures, the first pair of arms 46 is preferably connected to an upper portion of the frame 24 and an upper portion of the support structure 12. The first pair of arms 46 is also preferably pivotally connected to the support structure 12 and the frame 24 to allow the height of the basketball goal 18 to be adjusted.

The connecting structure 32 may also include a second pair of arms 54 connected to the support structure 12 and the basketball goal 18. The second pair of arms 54 preferably includes a first end that is connected to the frame 24, such as the generally horizontal support members, by a fastener 56. The second end of the second pair of arms 54 is preferably connected to the support structure 12 by a fastener 58. The second pair of arms 54 is also preferably connected to a lower portion of the frame 24 of the basketball goal 18 and a lower portion of the support structure 12. In addition, the second pair of arms 54 is preferably pivotally connected to the support structure 12 and the basketball goal 18 by the fasteners 56, 58, respectively, to allow the height of the basketball goal to be readily adjusted.

The end of the second pair arms 54 may extend beyond the support structure 12 to allow the height adjustment mechanism 34 to be connected to the connecting structure 32. For example, as seen in FIGS. 1-3, the second pair of arms 54 may include rearwardly extending portions 60 that are connected to the height adjustment mechanism 34 by a bracket 62. It will be appreciated that the height adjustment mechanism 34 could be connected to any suitable portions of the connecting structure 32, and the height of the basketball goal 18 does not have to be adjustable. It will also be appreciated that the connecting structure 32 may have a variety of suitable sizes, shapes, configurations and arrangements depending, for example, upon the configuration of the basketball goal 18 and/or support structure 12. In addition, it will be appreciated that the support structure 12, basketball goal 18 and connecting structure 32 may be connected in other suitable manners and fashions.

One of ordinary skill in the art will appreciate that the basketball system 10 described herein could include other features, aspects, components and the like. In addition, one of ordinary skill in the art will appreciate that the basketball system 10 could have other suitable shapes, sizes, configurations and arrangements. For example, the basketball system 10 may have features, aspects, components, shapes, sizes, configurations and arrangements such as disclosed in U.S. Pat. Nos. 5,695,417; 5,879,247; 6,077,177; 6,120,396; 6,273,834; 6,645,095; 6,422,957; 6,142,891; 6,419,598; 6,699,146; 6,135,901; 6,419,597; 6,155,938; and 6,402,244. These patents are expressly incorporated by reference in their entireties. Thus, the basketball system 10 shown in the accompanying figures and described herein merely illustrates an exemplary basketball system that may be used in connection with the lighting system 64.

The lighting system 64 preferably includes an elongated support structure 66 with a first section 68 and a second section 70. As shown in FIG. 1, the first section 68 may extend generally vertically upward and the second section 70 may extend generally horizontally. The first section 68 is preferably connected to the second section 70 by a bracket 72. Thus, the first and section sections 68, 70 of the lighting support structure 66 may have a generally T-shaped configuration.

In greater detail, as shown in FIGS. 1, 3 and 5, the first section 68 may include a first segment 74 and a second segment 76 that are interconnected by a bracket 78. The first segment 74 is preferably an elongated member that extends along an axis in a generally straight line and the second segment 76 is preferably curved or arched. In particular, the second segment 76 is preferably curved at about a ninety degree angle (90°). Advantageously, this may make the first section 68 of the lighting support structure 66 easier to manufacture because the first segment 74 may simply be a relatively straight member and the second segment 76 may be a curved member. It will be appreciated, however, that the first section 68 could include any suitable number of segments or it could also be a unitary structure. It will also be appreciated that the segments 74, 76 may be connected in any suitable manner or fashion.

The second section 70 of the lighting support structure 66 is preferably a unitary structure that is connected to the end first section 68, but the second section could include any suitable number of components or parts. One or more lights are preferably attached to the ends of the second section 70. In particular, a first light 80 is preferably attached to a first end of the second section 70 and a second light 82 is preferably attached to a second end of the second section. The lights 80, 82 are preferably spaced apart to help illuminate the basketball goal 18 and prevent shadows. The lights 80, 82 are also preferably movable or adjustable so that the lights may face downwardly, sideways, upwardly, at various angles and the like. More preferably, the lights 80, 82 are movable or adjustable so that the lights can be positioned in any desired direction or location, but the lights do not have to be adjustable. It will be appreciated that the lighting system 64 could include any suitable number of lights 80, 82 and the lights could have various suitable arrangements and configurations.

The first and second sections 68, 70 of the lighting system 64 are preferably constructed from metal tubing, such as one inch by three inch rectangular tubing or two inch by three inch rectangular tubing. Advantageously, the metal tubing may be relatively strong and lightweight. In addition, wires may be disposed within the tubing to allow power to be supplied to the lights 80, 82. The lighting system 68, 70 may also be constructed from other suitable materials and may have other appropriate shapes, sizes, configurations and arrangements depending, for example, upon the intended use of the lighting system 64 and/or the basketball system 10.

The lighting system 64 is preferably movable relative to the support structure 12 between a first position in which the lighting system is capable of being used and a second position for maintenance or repair. For example, the lighting support structure 66 may be pivotally connected to the support structure 12 of the basketball system 10 to allow the lighting system 64 to move between the first and second positions. In particular, the first section 68 of the lighting support structure 66 is preferably pivotally connected to an upper portion of the support structure 12. In greater detail, the first segment 74 of the first section 68 of the lighting support structure 66 is preferably pivotally connected to the upper portion of the support structure 12.

Specifically, as best seen in FIGS. 2 and 4, the first segment 74 may be pivotally attached to the support structure 12 by a first bracket 84 and a second bracket 86. The first bracket 84 may include one end that is securely connected to the lighting support structure 66 and a second end that is securely connected to the second bracket 86. The second bracket 86 may be pivotally connected to the support structure 12 by the fastener 50. Thus, the fastener 50 may allow both the first pair of arms 46 of the connecting structure 32 and the lighting system 64 to be pivotally connected to the support structure 12.

Advantageously, a portion of the first and second brackets 84, 86 may be sized and configured to contact a portion of the bracket 52 attached to the upper portion of the support structure 12 when the lighting system 64 is in the use or first position. Thus, the brackets 52, 84, 86 may help support the weight of the lighting system 64 when the lighting system is in the first position.

When the lighting system 64 is in the first position, an attachment mechanism 88 may be used to secure the lighting system in the first position. The attachment mechanism 88 is preferably connected to an end of the first section 68 of the lighting support structure 66 and it is sized and configured to maintain the lighting system 64 in a stationary position relative to the support structure 12. For example, as shown in FIGS. 1 and 2, the attachment mechanism 88 may be a generally U-shaped bracket 90 that is sized and configured to be disposed about the support structure 12 and connected to the end of the lighting support structure 66.

In addition, when the lighting system 64 is in the first position, the first section 68 of the lighting support structure 66 may be disposed in a generally vertical alignment and it may be disposed generally parallel and adjacent to the upper portion of the support structure 12. The attachment mechanism 88 may be disposed about the support structure 12 and attached to the end of the lighting support structure 66 to secure the lighting system 64 in the first position. When it is desired to move the lighting system 64 from the first position to the second position, the attachment mechanism 88 may be disconnected and the lighting system may rotate or pivot relative to the support structure 12. Advantageously, the first section 68 of the lighting support structure 66 may allow the lighting system 64 to only pivot or move forwardly. Although not shown in the accompanying figures, it will be appreciated that a biasing mechanism may be used to bias the lighting system into a desired position and/or assist in moving the lighting system between the first and second positions.

When the lighting system 64 is in the second position, as shown in FIGS. 3 and 4, the attachment mechanism 88 is no longer attached to the support structure 12. In addition, the lighting system 64 preferably pivots forwardly and the lighting support structure 66 contacts the backboard 20. Specifically, the first section 68 of the lighting support structure 66 preferably contacts an upper portion of the backboard 20. Advantageously, the bracket 78 interconnecting the first and second sections 68, 70 may contact the backboard 20, which may help prevent damage to the lighting support structure 66, but any desired portion of the lighting system 64 may contact the backboard.

Significantly, when the lighting system 64 is in the second position, the lights 80, 82 may be easily replaceable. In particular, because the lighting support structure 66 contacts the backboard 20 and the second segment 76 is curved, the lights 80, 82 may be positioned at about the same height as the rim 26. Thus, the lights 80, 82 may be at a height of about ten feet when the rim 26 is at a height of about ten feet. Advantageously, if the basketball system 10 is height adjustable, then the height of the lighting system 64 may also be adjustable when the lighting system is in the second position. Therefore, adjusting the height of the basketball system 10 may also the height of the lights 80, 82 to be adjusted. This may allow, for example, the lights 80, 82 to be positioned at a relatively convenient height if the light bulbs need to be replaced. For instance, if the height of the rim 26 may be positioned at about six feet, then the height of the lights 80, 82 may also be positioned at about six feet which may make the lights mush easier to replace.

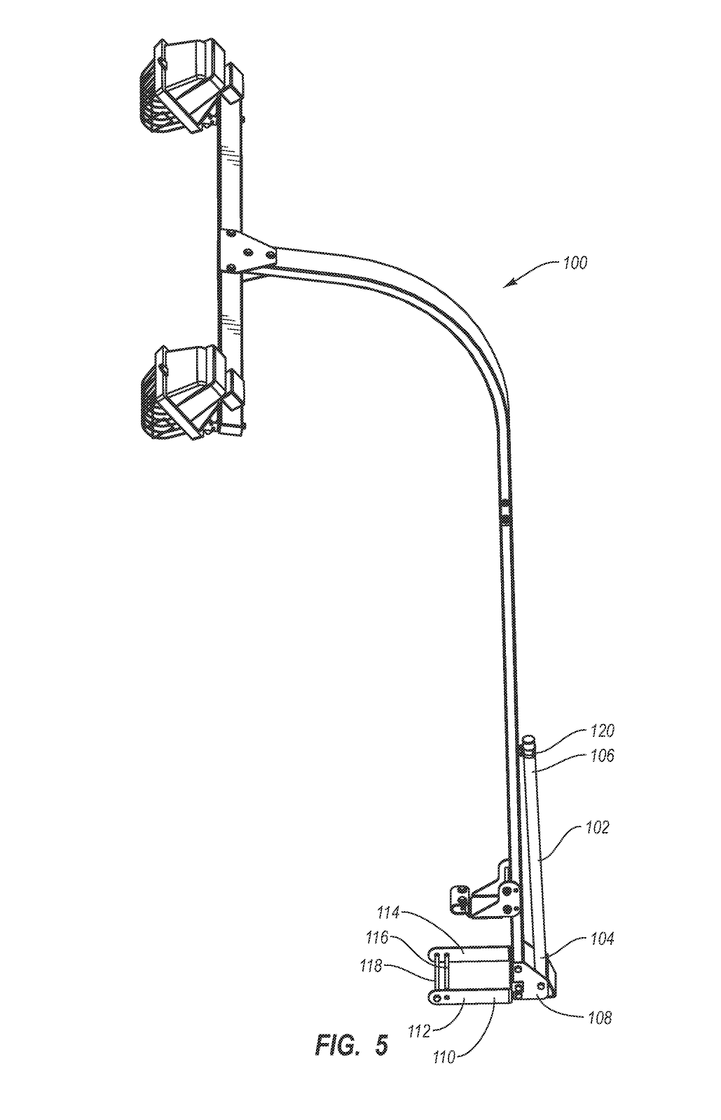

As shown in FIG. 5, the lighting system may have other suitable sizes, shapes, configurations and arrangements. For example, the lighting system 100 shown in FIG. 5 may include a handle 102 and the handle may be sized and configured to facilitate movement of the lighting system between the first and second positions. In particular, when the lighting system 100 is in the second position, the handle 102 may be sized and configured to help move the lighting system into the first position. It will be appreciated that the handle 102 could be used for different purposes and functions.

In greater detail, a first end 104 of the handle 102 may be pivotally attached to the lighting system 100 and a second end 106 of the handle may be movable relative to the lighting system. Preferably, the first end 104 of the handle 102 is pivotally connected to a bracket 108 that is connected to an end of the lighting system 100. The bracket 108 may also be used in connection with an attachment mechanism 110 to secure the lighting system 100 in the first position. The attachment mechanism 110 may include two outwardly extending flanges 112, 114 that are sized and configured to be disposed about the support structure when the lighting system is in the first position. One or more fasteners 116, 118 may be used to secure the attachment mechanism 110 to the support structure and maintain the lighting system 100 in the first position. It will be appreciated that the attachment mechanism 110 may also have other suitable shapes, sizes configurations and arrangements. For example, the flanges 112, 114 may be connected or disconnected to the bracket 108 and/or the support structure when it is desired to secure or release the lighting system 100 from the first position.

The lighting system 100 may also include other features and components. For example, the lighting system 100 could include a clip 120 that is sized and configured to receive the second end 106 of the handle 102. The clip 120 could selectively receive and maintain the second end 106 of the handle 102 in a fixed position and allow the handle to be selectively released. Thus, the clip 120 may help store the handle 102 in a desired position. The clip 120 may also have other purposes and functions. For example, the clip 120 may maintain the handle 102 in a permanently fixed position relative to the support structure, if desired.

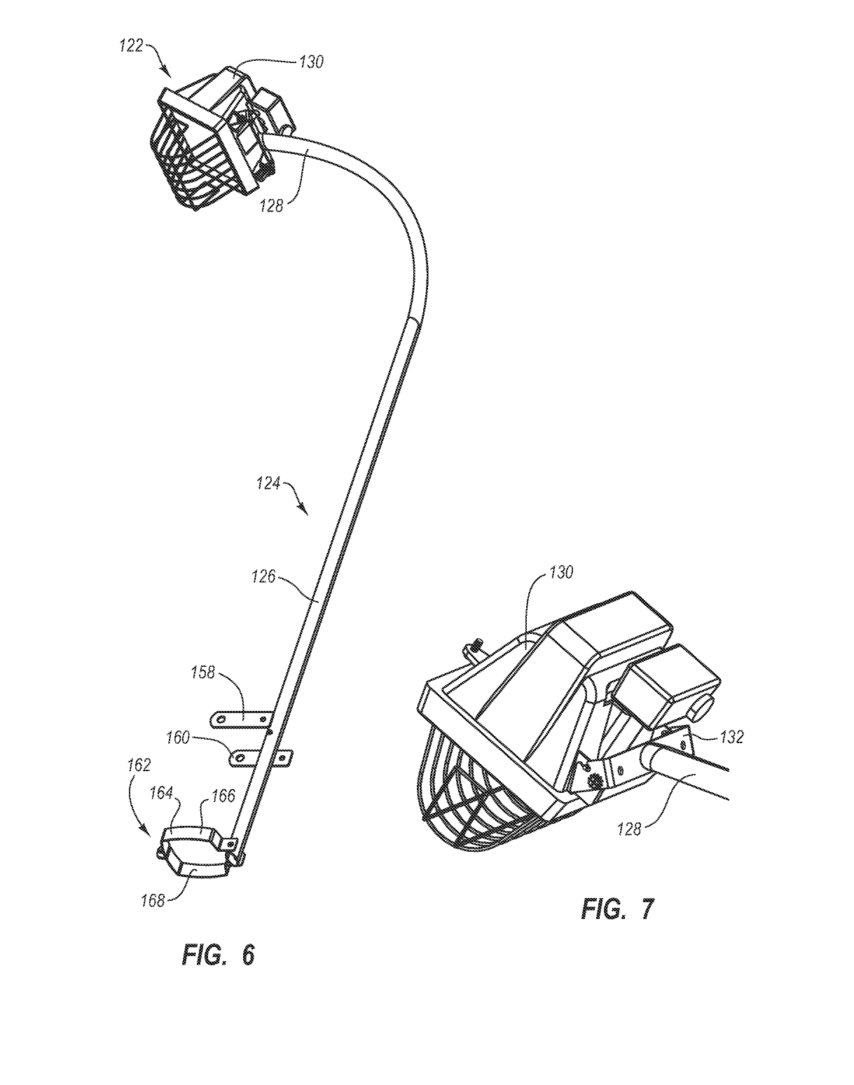

As shown in FIG. 6, the lighting system may have other suitable sizes, shapes, configurations and arrangements. For example, the lighting system 122 shown in FIG. 6 may include an elongated lighting support structure 124, which may include a first segment 126 and a second segment 128 connected to the first segment. The first segment 126 is preferably an elongated member that extends along an axis in a generally straight line and the second segment 128 is preferably curved or arched. It will be appreciated, however, that the lighting support structure 124 could include any suitable number of segments or it could also be a unitary structure.

One or more lights are preferably attached to the lighting support structure 124. In particular, as shown in FIGS. 6 and 7, a light 130 is preferably attached to an end of the lighting support structure 124 using a bracket 132. The bracket 132 may be sized and configured to permit the light 130 to be movable or adjustable so that the light may face downwardly, sideways, upwardly, at various angles and the like. More preferably, the bracket 132 is sized and configured to permit the light 130 to be movable or adjustable so that the light can be positioned in any desired direction or location, but the light does not have to be adjustable. It will be appreciated that the light 130 may be attached to the lighting support structure 124 using one or more brackets, connectors, fasteners, adhesives, welds and/or any other suitable means.

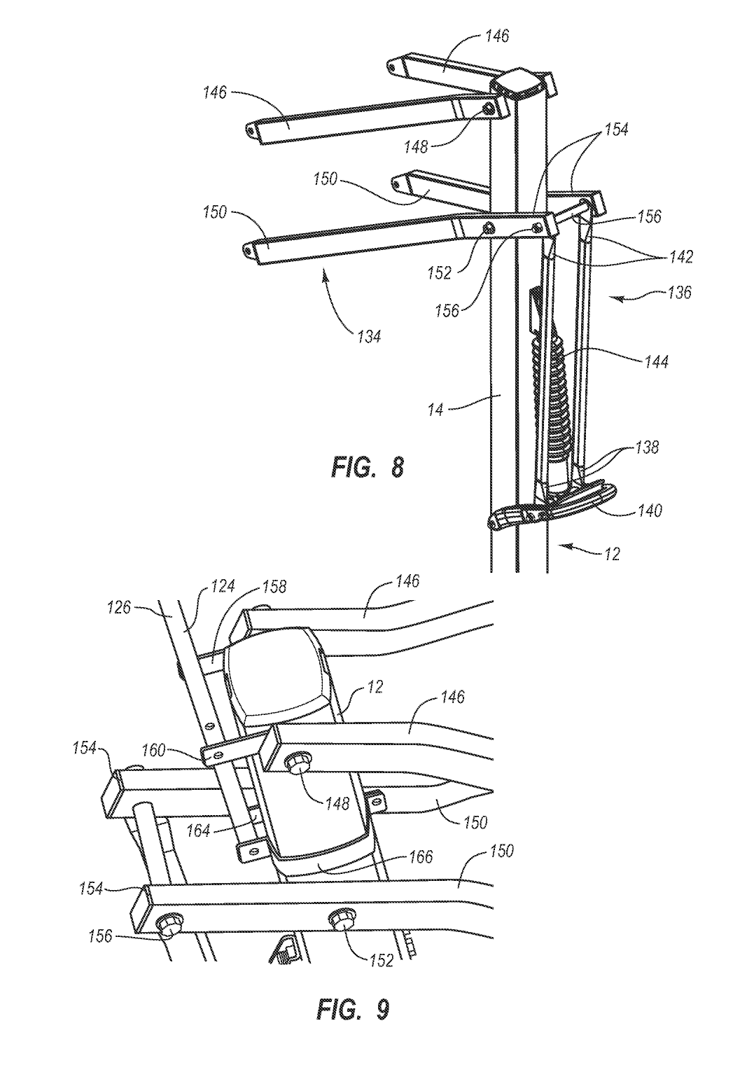

As shown in FIGS. 8 and 9, the lighting support structure 124 and a connecting structure 134 of a basketball system may be connected to the support structure 12. As discussed in greater detail below, the lighting support structure 124 and the connecting structure 134 may be interconnected. In particular, the lighting support structure 124 and the connecting structure 124 may both be interconnected and attached to the support structure of a basketball system. Advantageously, this may allow the lighting system to be quickly and easily attached to the basketball system. In addition, this may allow the lighting system to be connected to the basketball system with a small or minimum number of parts.

In greater detail, the connecting structure 134 preferably works in conjunction with a height adjustment mechanism 126 to allow the height of the basketball goal 18 to be adjusted. As shown in FIG. 8, the height adjustment mechanism 136 may include a first end 138 that is connected to the support structure 12 by a handle 140 and a second end 142 that is connected to a portion of the connecting structure 134. The height adjustment mechanism 136 may include one or more biasing members that are sized and configured to bias the basketball goal 18 into a desired position. In particular, the height adjustment mechanism 136 may include a biasing member 144 with one end connected to the first end 138 and/or handle 140 of the height adjustment mechanism and the other end connected to the support structure 12. The biasing member 144 may be sized and configured to bias the basketball goal 18 into a desired position and/or help maintain the basketball goal in a desired position. It will be appreciated that the height adjustment mechanism 136 and the biasing member 144 may have a variety of sizes, shapes, configurations and arrangements depending, for example, upon the intended use of the basketball system.

The connecting structure 134 preferably includes one or more support members or arms that connect the support structure 12 and the basketball goal 18. In particular, the connecting structure 134 may include a first pair of arms 146 connected to the support structure 12 and the basketball goal 18. One end of the first pair of arms 146 is preferably connected to the basketball goal 18, and the other end of the first pair of arms is preferably connected to the support structure 12 by a fastener 148. The connecting structure 134 may also include a second pair of arms 150 connected to the support structure 12 and the basketball goal 18. One end of the second pair of arms 150 is preferably connected to the basketball goal 18, and the other end of the second pair of arms is preferably connected to the support structure 12 by a fastener 152. The first and second pairs of arms 146, 150 are preferably pivotally connected to the support structure 12 and the basketball goal 18 to allow the height of the basketball goal to be adjusted.

The end of the second pair arms 150 may extend beyond the support structure 12 to allow the height adjustment mechanism 136 to be connected to the connecting structure 134. For example, as seen in FIG. 8, the second pair of arms 150 may include rearwardly extending portions 154 that are connected to the height adjustment mechanism 136 by a fastener 156. It will be appreciated that the height adjustment mechanism 136 could be connected to any suitable portions of the connecting structure 134, and the height of the basketball goal 18 does not have to be adjustable. It will also be appreciated that the connecting structure 134 may have a variety of suitable sizes, shapes, configurations and arrangements depending, for example, upon the configuration of the basketball goal 18 and/or support structure 12. In addition, it will be appreciated that the support structure 12, basketball goal 18 and connecting structure 134 may be connected in other suitable manners and fashions.

The lighting system 122 is preferably movable relative to the support structure 12 between a first position in which the lighting system is capable of being used and a second position for maintenance or repair. For example, the lighting support structure 124 may be pivotally connected to the support structure 12 to allow the lighting system 122 to move between the first and second positions. In particular, the first segment 126 of the lighting support structure 124 is preferably pivotally connected to the support structure 12. Specifically, as best seen in FIG. 9, the first segment 126 of the lighting support structure 124 may be pivotally attached to the support structure 12 by a first flange 158 and a second flange 160. The flanges 158, 160 may include one end that may securely connected to the lighting support structure 124 and a second end that may be pivotally connected to the support structure 12 by the fastener 148. Thus, the fastener 148 may allow both the first pair of arms 146 of the connecting structure 134 and the lighting system 122 to be pivotally connected to the support structure 12.

An attachment mechanism 162, such as shown in FIG. 6, may be used to secure the lighting system 122 in the first position. In greater detail, the attachment mechanism 162 may include a clamp 164 that includes a pair of jaws 166, 168 which are sized and configured to clamp onto the support structure 12 when the lighting system 122 is in the first position, such as shown in FIG. 9. One or more fasteners may be used to secure the attachment mechanism 162 to the support structure 12 and maintain the lighting system 122 in the first position. It will be appreciated that the attachment mechanism 162 may also have other suitable shapes, sizes configurations and arrangements.

Advantageously, the lighting systems 64, 100, 122 may not interfere with playing or practicing basketball because, when the lighting systems are in the first or use position, the lights 80, 82, 130 and the support structure 12 are preferably positioned behind the basketball goal 18. In particular, the lights 80, 82, 130 and the support structure 12 are preferably positioned behind the basketball backboard 20. Because the backboard 20 may be constructed from clear, transparent or translucent materials, light from the lighting systems 64, 100, 122 may pass through the backboard to illuminate the rim 26 and the playing surface.

The lights 80, 82, 130 and the support structure 12 also preferably remain behind the basketball goal 18 and backboard 20 in the first position even when the height of the basketball goal is being adjusted. That is, the lights 80, 82, 130 and the support structure 12 preferably always remain behind the basketball goal 18 and backboard 20 in the first position regardless of the height of the basketball system 10. The lights 80, 82, 130 and a portion of the support structure 12 are preferably only positioned in front of the basketball goal 18 and the backboard 20 when the lighting system 64, 100, 122 is in the second or maintenance position.

In operation, the lighting system 64, 100, 122 may be disposed in the first or use position to allow the basketball system 10 to be used by one or more players. When maintenance of the lighting system 64, 100, 122 is required, such as replacing the light bulbs, the attachment mechanism 88, 110, 162 may be detached or removed and the lighting system may be moved from the first position to the second position. In the second position, the lighting support structure 66, 124 preferably contacts an upper portion of the backboard 20 and the lights 80, 82, 130 are preferably disposed proximate the rim 26. The height adjustable mechanism 34, 136 for the basketball goal 18 may then be used to position the lighting system 64, 100, 122 at a desired height.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method for using a lighting system, the lighting system including a lighting support structure and one or more lights connected to the lighting support structure, the method comprising:
pivoting the lighting support structure from a position in which the lighting support structure is spaced apart from a backboard of a basketball goal to a position in which the lighting support structure contacts the backboard; and
adjusting the height of the basketball goal while the lighting support structure contacts the backboard to adjust the height of the one or more lights.

2. The method as in claim 1, wherein adjusting the height of the basketball goal while the lighting support structure contacts the backboard to adjust the height of the one or more lights comprises:
decreasing the height of the basketball goal while the lighting support structure contacts the backboard to decrease the height of the one or more lights.

3. The method as in claim 2, further comprising replacing a first light bulb of the one or more lights with a second light bulb.

4. The method as in claim 3, further comprising increasing the height of the basketball goal while the lighting support structure contacts the backboard to increase the height of the one or more lights.

5. The method as in claim 4, further comprising pivoting the lighting system back to a position in which the lighting support structure is spaced apart from the backboard.

6. The method as in claim 1, wherein adjusting the height of the basketball goal while the lighting support structure contacts the backboard to adjust the height of the one or more lights comprises:
increasing the height of the basketball goal while the lighting support structure contacts the backboard to increase the height of the one or more lights.

7. The method as in claim 1, further comprising pivoting the lighting system back to a position in which the lighting support structure is spaced apart from the backboard.

8. A method for using a lighting system, the lighting system including a lighting support structure and one or more lights connected to the lighting support structure, the method comprising:
pivoting the lighting support structure from a first position in which the one or more lights are positioned above a backboard of a basketball goal to a second position in which the one or more lights are positioned at least proximate a rim of the basketball goal.

9. The method as in claim 8, wherein the lighting support structure is spaced apart from the backboard when the lighting support structure is in the first position; and wherein the lighting support structure contacts the backboard when the lighting support structure is in the second position.

10. The method as in claim 9, further comprising adjusting the height of the basketball goal while the lighting support structure contacts the backboard to adjust the height of the one or more lights.

11. The method as in claim 10, wherein adjusting the height of the basketball goal while the lighting support structure contacts the backboard to adjust the height of the one or more lights comprises:
decreasing the height of the basketball goal while the lighting support structure contacts the backboard to decrease the height of the one or more lights.

12. The method as in claim 1, further comprising replacing a first light bulb of the one or more lights with a second light bulb.

13. The method as in claim 12, further comprising increasing the height of the basketball goal while the lighting support structure contacts the backboard to increase the height of the one or more lights.

14. The method as in claim 13, further comprising pivoting the lighting system back to a position in which the lighting support structure is spaced apart from the backboard.

15. The method as in claim 13, further comprising pivoting the lighting system back to a position in which the one or more lights are positioned above the backboard.

16. The method as in claim 10, wherein adjusting the height of the basketball goal while the lighting support structure contacts the backboard to adjust the height of the one or more lights comprises:
increasing the height of the basketball goal while the lighting support structure contacts the backboard to increase the height of the one or more lights.

17. The method as in claim 10, further comprising pivoting the lighting system back to a position in which the lighting support structure is spaced apart from the backboard.
